(19) United States
(12) Patent Application Publication
(10) Pub. No.: US 2013/0247821 A1
(43) Pub. Date: Sep. 26, 2013

(54) ADHESIVE APPLICATION APPARATUS FOR MANUFACTURING BLADE FOR WIND POWER GENERATOR

(71) Applicants: Sangmin Choi, Incheon (KR); Kihyun Kim, Daejeon (KR); Soohyun Eum, Namhae-gun (KR)

(72) Inventors: Sangmin Choi, Incheon (KR); Kihyun Kim, Daejeon (KR); Soohyun Eum, Namhae-gun (KR)

(73) Assignee: SAMSUNG HEAVY IND. CO., LTD., Seoul (KR)

(21) Appl. No.: 13/992,224

(22) PCT Filed: Dec. 2, 2011
(86) PCT No.: PCT/KR11/09310

§ 371 Date: Jun. 6, 2013

(30) Foreign Application Priority Data
Dec. 10, 2010 (KR) 10-2010-0126352

(51) Int. Cl. F03D 1/06

(52) U.S. Cl. CPC F03D 1/0675
USPC 118/313

(57) ABSTRACT

Disclosed is an adhesive application apparatus for manufacturing a blade for a wind power generator. The adhesive application apparatus for manufacturing a blade for a wind power generator according to an exemplary embodiment of the present invention may include: a blade mold on which a blade is mounted; a plurality of adhesive application units positioned to be spaced apart from the blade mold and configured to apply an adhesive on an inner surface of the blade; a horizontal transfer unit configured to transfer the adhesive application unit in a horizontal direction; and a vertical transfer unit configured to transfer the adhesive application unit in a vertical direction.

### TECHNICAL FIELD

The present invention relates to an adhesive application apparatus for manufacturing a blade for a wind power generator.

### BACKGROUND ART

Recently, in order to solve problems such as global warming, high oil prices, or the like, development of alternative energy as a substitute for petroleum resources is in the midst of being conducted. A wind power generator as alternative energy does not discharge any pollutant material nor cause damage to the environment, and therefore researches and development with respect to the corresponding technologies are actively being conducted.

In general, the wind power generator is classified into a vertical axis type in which a rotating axis is vertical to a wind direction, and a horizontal axis type in which a rotating axis is horizontal to a wind direction. Here, the vertical axis type is mainly used in a small-class wind power generator for producing low electric power, and the horizontal axis type is mainly used in a medium-class wind power generator to a large-class wind power generator for producing high electric power.

Among the wind power generators, a horizontal axis wind power generator is configured to include a nacelle fixedly installed on an end portion of a tower, a hub coupled to the nacelle, and a blade fixedly installed on a side surface of the hub. Here, the blade is formed to have an airfoil shaped cross-section, and installed on the hub so as to have a predetermined angle of attack with respect to wind which blows from a front side of the wind power generator. Therefore, the wind which blows from the front side of the wind power generator generates lift force while sliding on a surface of the blade, and the generated lift force rotates the blade and the hub. Here, torque generated by the blade is transmitted to the nacelle connected to the hub and converted into electrical energy.

At the time of manufacturing the blade, an adhesive needs to be applied on an inner wall of the blade to have uniform thickness and width, but because a process of applying the adhesive is generally manually performed, it is difficult to apply the adhesive with uniform thickness and width, and a long period of time is needed to apply the adhesive.

In addition, a process of applying the adhesive needs to be completed before the adhesive begins to be cured in consideration of a pot life of the adhesive, but because a process of applying the adhesive is manually performed, adhesion performance may deteriorate.

### DISCLOSURE

### Technical Problem

The present invention has been made in an effort to provide an adhesive application apparatus for manufacturing a blade for a wind power generator having advantages of being capable of reducing a process time for manufacturing the blade and improving qualities of the blade.

### Technical Solution

An exemplary embodiment of the present invention provides an adhesive application apparatus for manufacturing a blade for a wind power generator including: a blade mold on which a blade is mounted; a plurality of adhesive application units positioned to be spaced apart from the blade mold and configured to apply an adhesive on an inner surface of the blade; a horizontal transfer unit configured to transfer the adhesive application unit in a horizontal direction; and a vertical transfer unit configured to transfer the adhesive application unit in a vertical direction.

The horizontal transfer unit may include a first carriage and a second carriage, which move along a rail unit formed on a surface of the blade mold and face each other, a shaft which connects the first carriage and the second carriage to each other; and a slider which moves the adhesive application unit along the shaft.

The vertical transfer unit may include a first arm having a first one end portion which is connected to the shaft to be rotatable about the shaft; and a second arm having a second one end portion which is formed with a hinge shaft and connected to a first other end portion of the first arm, and configured to be rotatable about the hinge shaft, and the adhesive application unit may be connected to a second other end portion of the second arm.

The adhesive application apparatus may further include an adjustment unit connected to the horizontal transfer unit and the vertical transfer unit, in which the adjustment unit may adjust a horizontal transfer speed of the adhesive application unit and a vertical position of the adhesive application unit by controlling the horizontal transfer unit and the vertical transfer unit.

The adhesive application apparatus may further include an adhesive supply unit which supplies a main material and a curing agent of the adhesive to the adhesive application unit; and transfer lines which transfer the main material and the curing agent of the adhesive from the adhesive supply unit to the adhesive application unit.

The transfer lines may include a first transfer line through which the main material of the adhesive is transferred, a second transfer line through which the curing agent of the adhesive is transferred, and a mixing line to which the first transfer line and the second transfer line are connected and in which the main material and the curing agent of the adhesive are mixed.

The adhesive application apparatus may further include an adjustment unit which controls a mixture amount of the main material and the curing agent by controlling the adhesive supply unit or the mixing line.

A screw shape may be formed on an inner wall of the mixing line to mix the main material and the curing agent of the adhesive.

The mixing line may be positioned inside the second other end portion of the second arm.

A guide configured to adjust an application width and an application direction of the adhesive may be further installed at a discharge portion of the adhesive application unit.

The adhesive application apparatus may further include an adjustment unit which controls an application width and an application direction of the adhesive by controlling the guide.

### Advantageous Effects

According to the exemplary embodiment of the present invention, the adhesive may be formed on the entire part of the inner surface of the blade with uniform thickness and width.

In addition, the adhesive may be accurately applied at a predetermined position of the inner surface of the blade, which is set in advance, and quality uniformity of the blade may be improved by forming the adhesive on the inner surface of the blade with uniform thickness and width.

In addition, the adhesive may be applied on a slide inner surface to have a uniform width, and the adhesive may be easily applied even on a curved portion of the inner surface of the blade.

In addition, the adhesive may be applied on a shell adhesion portion of the blade immediately after the main material and the curing agent of the adhesive are mixed, and therefore a process of applying the adhesive may be completed before the adhesive begins to be cured.

In addition, a structure of the adhesive application apparatus may be simplified.

### DESCRIPTION OF THE DRAWINGS

FIG. 1 is a front view of an adhesive application apparatus for manufacturing a blade for a wind power generator according to an exemplary embodiment of the present invention.

FIG. 2 is a side view of a vertical transfer unit and an adhesive application unit of FIG. 1.

FIG. 3 is an enlarged view of a mixing line installed in a second arm of FIG. 2.

### MODE FOR INVENTION

Hereinafter, an adhesive application apparatus for manufacturing a blade for a wind power generator according to exemplary embodiments of the present invention will be described in detail with reference to the accompanying drawings. However, the present invention is not limited to the exemplary embodiment disclosed below, but may be implemented in various different forms. The present exemplary embodiments are for rendering the description of the present invention complete and are set forth to provide a complete understanding of the scope of the invention to a person skilled in the art.

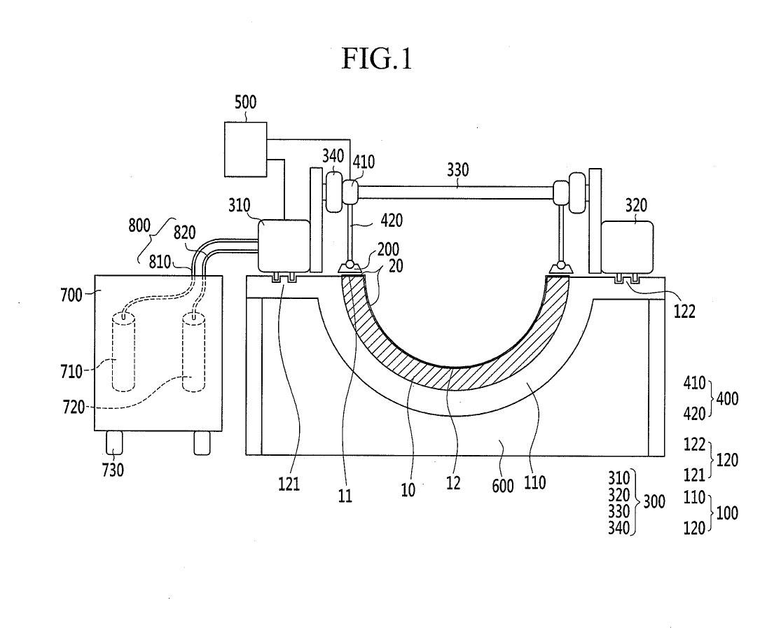

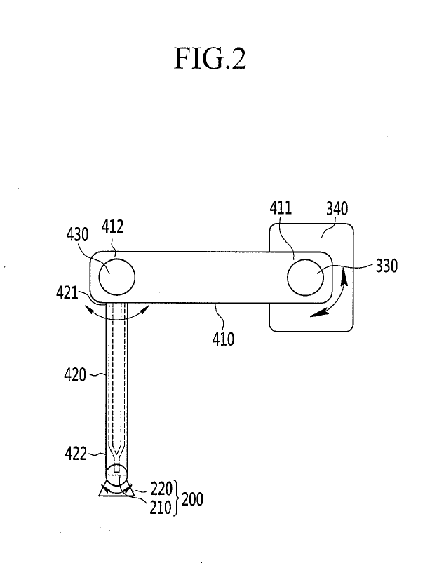

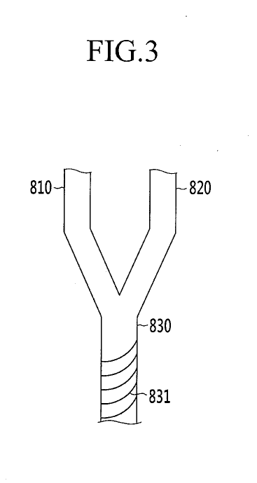

FIG. 1 is a front view of an adhesive application apparatus for manufacturing a blade for a wind power generator according to an exemplary embodiment of the present invention, FIG. 2 is a side view of a vertical transfer unit and an adhesive application unit of FIG. 1, and FIG. 3 is an enlarged view of a mixing line installed in a second arm of FIG. 2.

As illustrated in FIGS. 1 to 3, an adhesive application apparatus for manufacturing a blade for a wind power generator according to an exemplary embodiment of the present invention includes a blade mold 100 on which a blade 10 is mounted, a plurality of adhesive application units 200 positioned to be space apart from the blade mold 100 and configured to apply an adhesive 20 on an inner surface of the blade 10, a horizontal transfer unit 300 configured to transfer the adhesive application unit 200 in a horizontal direction, a vertical transfer unit 400 configured to transfer the adhesive application unit 200 in a vertical direction, and further includes an adjustment unit 500 connected to the horizontal transfer unit 300 and the vertical transfer unit 400.

The blade mold 100 includes a mold unit 110 on which a blade pattern is engraved, and rail units 120 having surfaces on which rails are formed. The blade 10 is formed on the mold unit 110 to have a shape identical to the blade pattern on the mold unit 110. The blade 10 is elongated along a streamlined side surface line so as to be in a shape having a semicircular cross section, and an inner surface of the blade 10 includes a shell adhesion portion 11 that is a portion to which a blade shell, which covers the blade 10, is adhered, and a shear web adhesion portion 12 that is a portion to which a blade shear web with which an inner portion of the blade 10 is filled is adhered.

The rail units 120 include a first rail unit 121 formed at a first side of the blade 10, and a second rail unit 122 formed at a second side of the mold unit 110, which faces the first side on the basis of the blade 10. The first rail unit 121 and the second rail unit 122 are formed along the streamlined side surface line of the blade 10. The blade mold 100 is mounted on a support 600 that fixes the blade mold 100. As such, the rail units 120 are directly formed on the blade mold 100 such that a structure of the adhesive application apparatus may be simplified because it is not necessary to install a separate rail device for transferring the adhesive application unit 200.

The horizontal transfer unit 300 includes a first carriage 310 and a second carriage 320, which move along the rail units 120 formed on the surfaces of the blade mold 100 and face each other, a shaft 330 which connects the first carriage 310 and the second carriage 320 to each other, and a slider 340 which moves the adhesive application unit 200 along the shaft 330.

The first carriage 310 moves along the first rail unit 121, and the second carriage 320 moves along the second rail unit 122. The shaft 330 has a length greater than a width of the blade 10 so that the adhesive 20 may be applied on the entire inner surface of the blade 10. Therefore, the adhesive application unit 200 may be transferred in a first horizontal direction when the first carriage 310 and the second carriage 320 are moved, the adhesive application unit 200 may be transferred in a second horizontal direction when the slider 340 is moved, and as a result, the adhesive 20 may be applied on the shell adhesion portion 11 and the shear web adhesion portion 12 of the inner surface of the blade 10 while the adhesive application unit 200 is transferred in all horizontal directions.

As illustrated in FIG. 2, the vertical transfer unit 400 includes a first arm 410 connected to the shaft 330, and a second arm 420 connected to the first arm 410. The first arm 410 includes a first one end portion 411 connected to the shaft 330, and a first other end portion 412 connected to the second arm 420, and the first arm 410 may be rotated at a predetermined angle about the shaft 330. The second arm 420 includes a second one end portion 421 connected to the first other end portion 412 of the first arm 410, and a second other end portion 422 connected to the adhesive application unit 200, and the second arm 420 may be rotated at a predetermined angle about a hinge shaft 430 which penetrates the first other end portion 412 of the first arm 410 and the second one end portion 421 of the second arm 420. As such, the first arm 410 and the second arm 420 of the vertical transfer unit 400 are rotated about the shaft 330 and the hinge shaft 430, respectively, such that a vertical position of the adhesive application unit 200 connected to the vertical transfer unit 400 may be adjusted, and as a result, the adhesive 20 may be applied on the shell adhesion portion 11 and the shear web adhesion portion 12, which have different heights, of the inner surface of the blade 10.

Referring back to FIG. 1, the adjustment unit 500 adjusts a horizontal transfer speed of the adhesive application unit 200 by adjusting the horizontal transfer unit 300, and adjusts a vertical position of the adhesive application unit 200 by adjusting the vertical transfer unit 400 such that the adhesive 20 is accurately applied at a predetermined position of the inner surface of the blade 10, which is set in advance based on CAD information, or the like.

An adhesive supply unit 700 which supplies a main material and a curing agent of the adhesive 20 to the adhesive application unit 200, and transfer lines 800 which transfer the main material and the curing agent of the adhesive 20 from the adhesive supply unit 700 to the adhesive application unit 200 are provided at a position spaced apart from the blade mold 100 at a predetermined distance.

A main material container 710 and a curing agent container 720 are installed in the adhesive supply unit 700 to store the main material and the curing agent of the adhesive 20, respectively, and transfer wheels 730 are installed below the adhesive supply unit 700, and therefore the adhesive supply unit 700 may be moved together with the movements of the first carriage 310 and the second carriage 320 in a direction in which the first carriage 310 and the second carriage 320 move.

As illustrated in FIG. 3, the transfer lines 800 include a first transfer line 810 through which the main material of the adhesive 20 is transferred, a second transfer line 820 through which the curing agent of the adhesive 20 is transferred, and a mixing line 830 to which the first transfer line 810 and the second transfer line 820 are connected and in which the main material and the curing agent of the adhesive 20 are mixed.

The first transfer line 810 connects the main material container 710 of the adhesive supply unit 700 and the mixing line 830, and the second transfer line 820 connects the curing agent container 720 of the adhesive supply unit 700 and the mixing line 830. A screw shape 831 is formed on an inner wall of the mixing line 830 to easily mix the main material and the curing agent of the adhesive 20, and the mixing line 830 may be positioned inside the second other end portion 422 of the second arm 420.

As such, the mixing line 830 is disposed adjacent to the adhesive application unit 200 such that the adhesive 20 is applied on the shell adhesion portion 11 and the shear web adhesion portion 12 of the blade 10 immediately after the main material and the curing agent of the adhesive 20 are mixed, and therefore a process of applying the adhesive 20 may be completed before the adhesive 20 begins to be cured.

The adhesive application unit 200 includes a discharge portion 210 through which the adhesive 20 is injected, and a guide 220 installed at the discharge portion 210 to be capable of adjusting an angle thereof and having a predetermined width. The adhesive application unit 200 may adjust an application width and an application direction of the adhesive 20 by using the guide 220 such that the adhesive 20 may be applied on a slide inner surface to have a uniform width, and an angle of the guide 220 may be adjusted such that the adhesive 20 may be easily applied even on a curved portion of the inner surface of the blade 10.

With reference to FIG. 1, it has been described that the adjustment unit 500 may control a horizontal position and a vertical position of the adhesive application unit 200 by controlling the horizontal transfer unit 300 and the vertical transfer unit 400.

However, a function of the adjustment unit 500 according to the exemplary embodiment of the present invention is not limited to the aforementioned example, but the adjustment unit 500 may further perform various functions in accordance with an environment in which the adhesive is applied.

In more detail, the adjustment unit 500 may control one or more of the adhesive supply unit 700, the first carriage 310, the second carriage 320, the mixing line 830, and the guide 220.

For example, the adjustment unit 500 may control a discharge amount of the adhesive of the adhesive application unit 200 by controlling one or more of the adhesive supply unit 700, and the mixing line 830. In this case, the adjustment unit 500 may further control a mixture ratio between the main material and the curing agent by controlling one or more of the main material container 710 and the curing agent container 720 of the adhesive supply unit 700 (the first transfer line 810 and/or the second transfer line 820 in some cases).

For example, the adjustment unit 500 may control a moving speed of the adhesive application unit 200 by controlling a moving speed of one or more of the first carriage 310 and the second carriage 320 on the first rail unit 121 and the second rail unit 122 formed in a longitudinal direction of the blade 1. Here, when the adjustment unit 500 controls a moving speed of the adhesive application unit 200, one or more of a required thickness of the adhesive, a required discharge amount of the adhesive, and a spaced distance between the adhesive application unit 200 and the adhesion portions 11 and 12 may be considered.

For example, the adjustment unit 500 may control the guide 220 of the adhesive application unit 200. More specifically, it has been described above that, when it is assumed that two shear webs are adhered to the blade 10 illustrated in FIG. 1 in a longitudinal direction of the blade, a position of the adhesive application unit 200, moving speeds of the blade 10 in a longitudinal direction and a width direction thereof, and a discharge amount of the adhesive may be controlled by the adjustment unit 500. Although not illustrated in FIG. 2, according to another exemplary embodiment of the present invention, a drive unit (not illustrated) may be further provided to rotate the guide 200 based on the second other end portion 422 at a predetermined angle. Further, the adjustment unit 500 may control a rotating angle of the guide 200 by controlling the drive unit (not illustrated). The curvature of the curved portion to which the shear web is adhered may be different in the longitudinal direction of the blade. Therefore, according to another exemplary embodiment of the present invention, there is a merit in that the adjustment unit 500 controls an angle of the guide 220 in correspondence to the curvature that becomes different in the longitudinal direction of the blade, and thus adhesive application may be uniform.

As describe above, the present invention has been described with reference to the exemplary embodiments illustrated in the drawings. However, the present invention is not limited to the exemplary embodiments, but various modified exemplary embodiments or another exemplary embodiment may be made by a person skilled in the art within the equivalent scope of the present invention. Therefore, the true protective scope of the present invention should be determined by the appended claims.

<Description of symbols>

| | |
|---|---|
| 100: Blade mold | 200: Adhesive application unit |
| 300: Horizontal transfer unit | 400: Vertical transfer unit |
| 500: Adjustment unit | 600: Support |
| 700: Adhesive supply unit | 800: Transfer line |

1. An adhesive application apparatus for manufacturing a blade for a wind power generator, comprising:
a blade mold on which a blade is mounted;
a plurality of adhesive application units positioned to be spaced apart from the blade mold and configured to apply an adhesive on an inner surface of the blade;
a horizontal transfer unit configured to transfer the adhesive application unit in a horizontal direction; and
a vertical transfer unit configured to transfer the adhesive application unit in a vertical direction.

2. The adhesive application apparatus of claim 1, wherein:
the horizontal transfer unit includes:
a first carriage and a second carriage, which move along a rail unit formed on a surface of the blade mold and face each other;
a shaft which connects the first carriage and the second carriage to each other; and
a slider which moves the adhesive application unit along the shaft.

3. The adhesive application apparatus of claim 2, wherein:
the vertical transfer unit includes:
a first arm having a first one end portion which is connected to the shaft to be rotatable about the shaft; and
a second arm having a second one end portion which is formed with a hinge shaft and connected to a first other end portion of the first arm, and configured to be rotatable about the hinge shaft, and
the adhesive application unit is connected to a second other end portion of the second arm.

4. The adhesive application apparatus of claim 3, further comprising:
an adjustment unit connected to the horizontal transfer unit and the vertical transfer unit,
wherein the adjustment unit adjusts a horizontal transfer speed of the adhesive application unit and a vertical position of the adhesive application unit by controlling the horizontal transfer unit and the vertical transfer unit.

5. The adhesive application apparatus of claim 3, further comprising:
an adhesive supply unit which supplies a main material and a curing agent of the adhesive to the adhesive application unit; and
transfer lines which transfer the main material and the curing agent of the adhesive from the adhesive supply unit to the adhesive application unit.

6. The adhesive application apparatus of claim 5, wherein:
the transfer lines include:
a first transfer line through which the main material of the adhesive is transferred;
a second transfer line through which the curing agent of the adhesive is transferred; and
a mixing line to which the first transfer line and the second transfer line are connected and in which the main material and the curing agent of the adhesive are mixed.

7. The adhesive application apparatus of claim 6, further comprising:
an adjustment unit which controls a mixture amount of the main material and the curing agent by controlling the adhesive supply unit or the mixing line.

8. The adhesive application apparatus of claim 6, wherein:
a screw shape is formed on an inner wall of the mixing line to mix the main material and the curing agent of the adhesive.

9. The adhesive application apparatus of claim 6, wherein:
the mixing line is positioned inside the second other end portion of the second arm.

10. The adhesive application apparatus of claim 1, wherein:
a guide configured to adjust an application width and an application direction of the adhesive is further installed at a discharge portion of the adhesive application unit.

11. The adhesive application apparatus of claim 10, further comprising:
an adjustment unit which controls an application width and an application direction of the adhesive by controlling the guide.
